(19) United States
(12) Patent Application Publication
(10) Pub. No.: US 2012/0242488 A1
(43) Pub. Date: Sep. 27, 2012

(54) PERSONAL THREAT NOTIFICATION

(76) Inventor: Eric Edward Wilson, Lake Mary, FL (US)

(21) Appl. No.: 13/420,392

(22) Filed: Mar. 14, 2012

Related U.S. Application Data
(60) Provisional application No. 61/466,705, filed on Mar. 23, 2011.

(51) Int. Cl. G01W 1/00; G08B 21/00

(52) U.S. Cl. 340/601; 340/686.6

(57) ABSTRACT

An apparatus, system, and method for personal threat notification. The method includes determining a device location. The device location is a location of a device. The method includes determining a threat location. The threat location includes a location of a threat. The method includes presenting a notification to the device in response to determining that the threat location is within a predetermined distance of the device location.

### CROSS-REFERENCES TO RELATED APPLICATIONS

This application claims the benefit of U.S. Provisional Patent Application No. 61/466,705 entitled “GPS Public Personal Weather Forecast and Warning System connecting social platform linking social business” and filed on Mar. 23, 2011, for Eric Edward Wilson, which is incorporated herein by reference.

### BACKGROUND

1. Field

The subject matter disclosed herein relates to threat notifications and more particularly relates to providing a personal threat notification on a device.

2. Description of the Related Art

The weather often plays an important part in daily life, determines activities and affects safety. A user can typically tune to weather stations, news, internet sites and mobile applications for obtaining weather information. This weather information is often general and for broad geographic areas.

Current weather warning systems often depend on a user being indoors and having power. As a result, those that may be affected by severe weather, including those, away from traditional broadcast methods (away from power and shelter), may not receive a warning.

### SUMMARY

From the foregoing discussion, it should be apparent that a need exists for a personal threat notification apparatus, system, and method. Beneficially, such an apparatus, system, and method would provide a personal threat notification to a device in response to determining that a threat is within a predetermined distance of the device.

The present subject matter has been developed in response to the present state of the art, and in particular, in response to the problems and needs in the art that have not yet been fully solved by currently available warning systems. Accordingly, the present subject matter has been developed to provide an apparatus, system, and method for personal threat notification that overcome many or all of the above-discussed shortcomings in the art.

A method is presented for personal threat notification. In one embodiment, the method includes determining a threat location. The threat location may include a geographic location of a device. In one embodiment, the method includes determining a threat location. The threat location may include a geographic location of a threat. In one embodiment, the method includes presenting a notification to the device in response to determining that the threat location is within a predetermined distance of the threat location.

In a further embodiment, the method includes associating a second device with the device and determining a second device location. The second device location may include a geographic location of the second device. In a further embodiment, the method includes determining a second threat location. The second threat location may include a geographic location of a second threat. In a further embodiment, the method includes presenting a notification to the device in response to determining that the second threat location is within a predetermined distance of the second device location.

In one embodiment, the method includes determining a first available communication option of a hierarchy of communication options for communicating with the device. In a further embodiment, presenting the notification to the device further includes sending the notification to the device using the first available communication option.

In one embodiment, the method includes determining an initial location. In a further embodiment, the method includes referencing a calendar event. The calendar event may include an event location and an event time. In a further embodiment, the method includes determining a route of travel from the initial location to the event location. In a further embodiment, the method includes determining that a second threat intersects with the route of travel. In one embodiment, the method includes presenting a second notification to the device in response to determining that the second threat intersects with the route of travel.

In one embodiment, determining the threat location further includes determining a device vector and determining the threat location further includes determining a threat vector. The device vector may include a vector of the device and the threat vector may include a vector of the threat. In a further embodiment, the method further includes determining that the device vector intersects with the threat vector, and presenting the notification to the device further includes presenting the notification to the device in response to determining that the threat location is within a predetermined distance of the threat location and that the device vector intersects with the threat vector.

In one embodiment, the method includes referencing a plurality of threat data collections for a plurality of threats. In a further embodiment, determining the threat location further includes determining the threat location of the threat based on data for the threat in one or more of the threat data collections. In one embodiment, presenting the notification to the device in response to determining that the threat location is within the predetermined distance of the threat location further includes repeating determining the threat location and the device location in response to determining that the threat location is within the predetermined distance of the threat location and presenting the notification to the device in response to making a second determination that the threat location is within the predetermined distance of the threat location.

In one embodiment, the notification includes an identification of the threat and an intersection time. The intersection time includes an estimated time of intersection of the threat with the device. In one embodiment, the method includes initiating a local entity search on the device. In a further embodiment, the device detects a local wireless transmission signal and displays a presentation associated with the local wireless transmission signal in response to initiating a local entity search on the device.

In one embodiment, the method includes receiving a request for additional information and displaying collaborative information associated with the threat in response to receiving the request for additional information.

The apparatus for personal threat notification is provided with a plurality of modules configured to functionally execute the steps of determining a threat location, determining a threat location, presenting a notification to a device, associating a second device with the device, and sending a second notification to the device. These modules in the described embodiments include a device location module, a threat location module, a notification module, an association module, and an associated device notification module.

The apparatus, in one embodiment, includes a communication determination module determining a first available communication option of a hierarchy of communication options for communicating with the device. In a further embodiment, sending the notification to the device further includes sending the notification to the device using the first available communication option. In one embodiment, the apparatus includes a calendar integration module referencing a first calendar event. The first calendar event includes a first event location and a first event time. In a further embodiment, the calendar integration module references a second calendar event. The second calendar event includes a second event location and a second event time. In a further embodiment, the apparatus includes a route intersection module determining a route of travel from the first event location to the second event location and determining that a second threat intersects with the route of travel.

In one embodiment, the device location module determines a device vector. The device vector may include a vector of the device. In a further embodiment, the threat location module determines a threat vector. The threat vector may include a vector of the threat. In a further embodiment, the apparatus includes an intersection module determining an intersection time of the device vector and the threat vector. In a further embodiment, the notification module sending the notification to the device further includes the notification module sending the intersection time.

A computer program product including a computer readable storage medium having computer readable program code embodied therein is also presented for personal threat notification. In one embodiment, the computer program product includes computer readable program code configured to determine a threat location. The threat location may include a geographic location of a device. In one embodiment, the computer readable program code is configured to determine a threat location. The threat location may include a geographic location of a threat. In one embodiment, the computer readable program code is configured to determine a first available communication option of a hierarchy of communication options for communicating with the device. In one embodiment, the computer readable program code is configured to send a notification to the device in response to determining that the threat location is within a predetermined distance of the threat location using the first available communication option.

In one embodiment, the computer readable program code is configured to associate a second device with the device and determine a second device location. The second device location may include a geographic location of the second device. In a further embodiment, the computer readable program code is configured to determine a second threat location. The second threat location may include a geographic location of a second threat. In a further embodiment, the computer readable program code is configured to send a second notification to the device in response to determining that the second threat location is within a predetermined distance of the second device location.

In one embodiment, the computer readable program code is configured to reference a first calendar event. The first calendar event includes a first event location and a first event time. In a further embodiment, the computer readable program code is configured to reference a second calendar event. The second calendar event includes a second event location and a second event time. In a further embodiment, the computer readable program code is configured to determine a route of travel from the first event location and the second event location and determine that a second threat intersects with the route of travel.

Another method is presented for personal threat notification. In one embodiment, the method includes determining a vantage point of a device. The vantage point may include a location and a viewing angle. In one embodiment, the method includes determining a threat potential of a potential threat element in the vantage point. In one embodiment, the method includes presenting a notification to the device. The notification may include the threat potential of the potential threat element.

In one embodiment, the method includes referencing atmospheric data corresponding to the vantage point. The atmospheric data may include atmospheric location data and atmospheric modeling data. In a further embodiment, the method includes creating one or more atmospheric images approximating the vantage point. The one or more atmospheric images may be created from the atmospheric data. In a further embodiment, the method includes presenting the one or more atmospheric images to the device.

Reference throughout this specification to features, advantages, or similar language does not imply that all of the features and advantages that may be realized with the present subject matter should be or are in any single embodiment of the subject matter. Rather, language referring to the features and advantages is understood to mean that a specific feature, advantage, or characteristic described in connection with an embodiment is included in at least one embodiment of the present subject matter. Thus, discussion of the features and advantages, and similar language, throughout this specification may, but do not necessarily, refer to the same embodiment.

Furthermore, the described features, advantages, and characteristics of the subject matter may be combined in any suitable manner in one or more embodiments. One skilled in the relevant art will recognize that the subject matter disclosed herein may be practiced without one or more of the specific features or advantages of a particular embodiment. In other instances, additional features and advantages may be recognized in certain embodiments that may not be present in all embodiments of the subject matter.

These features and advantages of the present subject matter will become more fully apparent from the following description and appended claims, or may be learned by the practice of the subject matter as set forth hereinafter.

### BRIEF DESCRIPTION OF THE DRAWINGS

In order that the advantages of the subject matter will be readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the accompanying drawings, in which:

FIG. 1A is a schematic block diagram illustrating one embodiment of a computing system;

FIG. 1B is a schematic block diagram illustrating one embodiment of a personal threat notification system in accordance with the present subject matter;

FIG. 2 is a schematic block diagram illustrating another embodiment of a personal threat notification system in accordance with the present subject matter;

FIG. 3 is a schematic block diagram illustrating one embodiment of a personal threat notification apparatus in accordance with the present subject matter;

FIG. 4 is a schematic block diagram illustrating another embodiment of a personal threat notification apparatus in accordance with the present subject matter;

FIG. 5 is a schematic block diagram illustrating one embodiment of a device within a predetermined distance of a threat in accordance with the present subject matter;

FIG. 6 is a schematic block diagram illustrating one embodiment of a vector of the device of FIG. 5 and a vector of the threat of FIG. 5 in accordance with the present subject matter;

FIG. 7 is a schematic block diagram illustrating one embodiment of a device displaying a threat and an intersection time in accordance with the present subject matter;

FIG. 8 is a schematic flow chart diagram illustrating one embodiment of a personal threat notification method in accordance with the present subject matter;

FIG. 9 is a schematic flow chart diagram illustrating another embodiment of a personal threat notification method in accordance with the present subject matter;

FIG. 10 is a schematic flow chart diagram illustrating yet another embodiment of a personal threat notification method in accordance with the present subject matter;

FIG. 11 is a schematic flow chart diagram illustrating one embodiment of a personal threat notification method with calendar integration in accordance with the present subject matter;

FIG. 12 is a schematic flow chart diagram illustrating one embodiment of a method to determine a threat potential in accordance with the present subject matter;

FIG. 13 is a schematic flow chart diagram illustrating another embodiment of a method to determine a threat potential in accordance with the present subject matter.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable storage medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireline, optical fiber, Radio Frequency (RF), or the like, or any suitable combination of the foregoing

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

Computer readable program code for carrying out operations for aspects of the present invention may be written in any combination of one or more programming languages, including an object oriented programming language such as Java, Smalltalk, C++, PHP or the like and conventional procedural programming languages, such as the “C” programming language or similar programming languages. The computer readable program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and computer program products according to embodiments of the invention. It will be understood that each block of the schematic flowchart diagrams and/or schematic block diagrams, and combinations of blocks in the schematic flowchart diagrams and/or schematic block diagrams, can be implemented by computer readable program code. The computer readable program code may be provided to a processor of a general purpose computer, special purpose computer, sequencer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The computer readable program code may also be stored in a computer readable medium that can direct a computer, other programmable data processing apparatus, or other devices to function in a particular manner, such that the instructions stored in the computer readable medium produce an article of manufacture including instructions which implement the function/act specified in the schematic flowchart diagrams and/or schematic block diagrams block or blocks.

The computer readable program code may also be loaded onto a computer, other programmable data processing apparatus, or other devices to cause a series of operational steps to be performed on the computer, other programmable apparatus or other devices to produce a computer implemented process such that the program code which executed on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and computer readable program code.

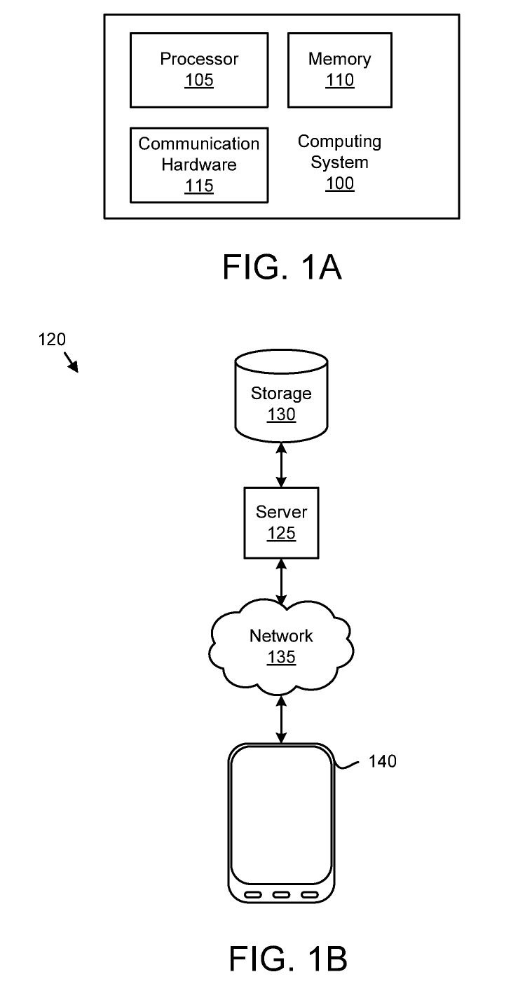

FIG. 1A is a schematic block diagram illustrating one embodiment of a computing system 120. In the depicted embodiment, the computing system 120 includes a processor 105, a memory 110, and communication hardware 115. The memory 110 may store machine-readable code. The memory 110 may be a semiconductor storage device, a hard disk drive, and optical storage device, and/or combinations thereof. The processor 105 may execute the machine-readable code. In certain embodiments, all or a portion of the digit identification apparatus described above may be stored on machine-readable code and executed by the processor. The computing system 120 may communicate with other devices through the communication hardware 115.

FIG. 1B depicts one embodiment of a personal threat notification system 120 in accordance with the present subject matter. The system 120 includes a server 125, a network 135, and a client device 140. The server 125 may interface with the client device 140 over the network 135. The server 125 may communicate with a central database stored in storage 130 to store data relating to threats, user data, and the like.

The server 125 may be embodied as a computing device such as a desktop computer, a server, a mainframe computer, and the like. The server 125 may comprise one embodiment of the computing system in FIG. 1A. The server 125 may include memory storing computer readable programs and may include one or more processors that execute the computer readable programs. The computer readable programs may be tangibly stored in storage in communication with the server 125. Although a single server 125 is depicted, in certain embodiments, the system 120 may include multiple servers and may be implemented using cloud computing with multiple server-based computational resources.

In one embodiment, the network 135 comprises a mobile phone telecommunications network such as a 3rd generation (“3G”) or 4th generation (“4G”) mobile telecommunications network, a 4th generation Long Term Evolutionmobile telecommunications, (“4GLTE”) network, and the like. In one embodiment, the network 135 is a global communications network 135 such as the Internet, a Local Area Network (“LAN”), multiple LANs communicating over the internet, or any other suitable communications network 135.

The client device 140 may be embodied as a device in communication with the server 125 over the network 135. The client device 140 may comprise one embodiment of the computing system in FIG. 1A and/or may comprise a portion of the components of the computing system in FIG. 1A. The client device 140, in the depicted embodiment, is a Smartphone. In other embodiments, the client device 140 may be embodied as a handheld computing device, a touch device, a personal desktop assistant (“PDA”), a tablet computer, a notebook computer, a mobile phone, and/or the like. In one embodiment, the client device 140 is a desktop computer or other suitable computing device. In one embodiment, the client device 140 is a signal transmission device such as a Radio-frequency identification (“RFID”) device or a Global Positioning System (“GPS”) device. In one embodiment, the client device 140 includes and/or is in communication with an electronic display, such as a liquid crystal display (“LCD”), plasma display, or other suitable display. In one embodiment, the display is a touch display capable of receiving touch input as is known in the art. The client device 140 may include and/or be in communication with a navigational device such as a GPS device. In one embodiment, the client device 140 is fixed in space. Specifically, in one embodiment, the client device 140 is a television (e.g. a television mounted on a user's wall). The television may be embodied as a television capable of executing “widgets”—applications that allow a television viewer to view web pages and other tools along with television programs.

One or more applications may operate on the client device 140. In one embodiment, the client device 140 interacts with the server 125 periodically when executing the one or more applications. For example, the client 140 may be periodically backed up by synchronization with the server 125 and storage 130. The client device 140 may also include a user interface for access to the one or more applications. In one embodiment, a client device 140 communicates with the server 125 by way of an application, such as an Internet browser, executing on the client device 140 and accesses and/or downloads web pages of the server 125 through the application. Each web page may include software code such as Hypertext Markup Language (“HTML”) code and/or JavaScript code, images, text, static and/or dynamic elements, animation, and the like.

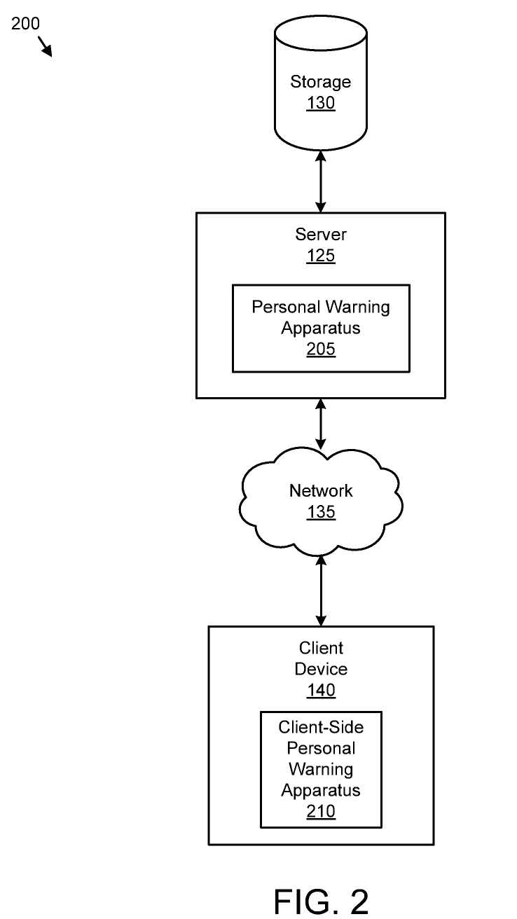

FIG. 2 depicts another embodiment of a personal threat notification system 200 in accordance with the present subject matter. The description of the system 200 refers to elements of FIG. 1, like numbers referring to like elements. The system 200 includes the storage 130, the server 125, the network 135, and the client device 140, that may be substantially similar to the like numbered elements depicted in FIG. 1.

The central server 125 includes a personal warning apparatus 205 to provide information and notifications of threats specific to users through the users' devices 140, such as the client device 140. These threats may include tornados, flooding, severe thunderstorms, marine warnings and others. In one embodiment, the personal warning apparatus 205 allows a user to register a device, such as the client device 140 in the depicted embodiment.

A registered device, as used herein, is a device 140 in which a user has registered with the personal warning apparatus 205. For example, a user, through the user's user account, may register a device 140 using a phone number for the device 140, if the device 140 is a phone, an Internet Protocol (“IP”) address, or other unique identifier. In one embodiment, the personal warning apparatus 205 verifies a device 140 as part of the registration process. The personal warning apparatus 205 may verify a device 140 by requesting information on the user's cell phone account for the device 140, sending a text message to the device 140 to which the user may respond to for verification, and/or the like.

The personal warning apparatus 205 may then store a record of the registered device 140 (e.g. on storage 130) and detect threats with a predetermined distance of the registered device, sending a notification to the registered device 140 alerting the user of threats. In one embodiment, the personal warning apparatus 205 provides users with user accounts. The personal warning apparatus 205 may store user account data on the storage 130.

In one embodiment, the personal warning apparatus 205 provides and/or integrates with a social networking platform to allow users to share information, view the status of other users, view threats, and/or the like. The social networking platform may host, store, include and/or provide web-based social networking and/or a web-based social networking website for access over the network 135 by a plurality of clients 140.

In one embodiment, the personal warning apparatus 205 allows a user to receive notifications when other users come into proximity with a threat. Specifically, in one embodiment, a user makes a connection with another user by creating an association with the additional user through the user's user profile and/or associating the user's client device 140 with the additional user's client device 140 as described below. The personal warning apparatus 205 may then send a notification to the user's device 140 when a threat is near the additional user's device. Furthermore, in certain embodiments, the user may also view locations of associated devices, such as on a map displayed on the social networking platform.

In certain embodiments, the personal warning apparatus 205 makes a temporary association of a device 140 with a second device 140. For example, a user may request a temporary association of a device 140 with a transmitter device 140 for a day while the user is at a theme park. The personal warning apparatus 205 may create the temporary association, which will expire after a certain time period (e.g. a day). In one embodiment, the user may request to view a location of the associated device. For example, if a father requests a temporary association of his device 140 with a device which is placed on a child, the father may view the child's location (e.g. the location of the device) if the child gets lost. In one embodiment, an associated device 140 is a device that transmits a local transmission signal such as an RFID transmitter. In this embodiment, the personal warning apparatus 205 may interface with and/or receive location information of an associated device 140 from a local entity. For example, if a mother gives an associated device 140 to a child at a theme park, in one embodiment, the theme park may have equipment to detect a location of the local transmission device 140 and may communicate this information to the personal warning apparatus 205 which may forward this information to the mother's device 140.

In one embodiment, the personal warning apparatus 205 includes and/or is in communication with, a Geographic Information System (“GIS”). In one embodiment, the GIS manages, processes, and/or present various types of geographical data. The GIS may provide and/or generate visual data, such as maps, for use by the personal warning apparatus 205.

In one embodiment, the personal warning apparatus 205 provides the capability for a user to point the user's device 140 at a potential threat and determine the threat potential of the potential threat. In certain embodiments, the personal warning apparatus 205 creates one or more atmospheric images approximating a vantage point of a user's client device 140. The atmospheric images may be a volumetric model of a section of the vantage point of the atmosphere. In one embodiment, the images include and color coding to indicate attributes of the atmosphere.

In one embodiment, the personal warning apparatus 205 interfaces with a GPS device and related applications on the client device 140. For example, the personal warning apparatus 205 in certain embodiments, may receive location information from the GPS device and send notifications for display inside a user interface for the GPS device.

While the personal warning apparatus 205, in the depicted embodiment, is included in the server 125, in certain embodiments, all or a portion of the personal warning apparatus 205 may reside and/or be embodied outside the server 125 and/or on multiple servers.

The client device 140 includes the client-side personal warning apparatus 210. The client-side personal warning apparatus 210 may send and receive communication from the personal warning apparatus 205. Specifically, the client-side personal warning apparatus 210 may receive notifications from the personal warning apparatus 205 regarding threats to the client device 140 and/or threats to other client devices 140 associated with the client device 140. The client-side personal warning apparatus 210 may include a user-interface to display information and receive input from the user.

In one embodiment, the user interface is provided by the client-side personal warning apparatus 210 in the form of an application. In one embodiment, at least a portion of the user interface includes and/or is integrated with a web browser that displays web pages from the server/personal warning apparatus 205. The client-side personal warning apparatus 210 may be in communication with and/or integrated with a navigation device, such as a GPS device. As described above, in certain embodiments, the client-side personal warning apparatus receives notifications through a user interface for the GPS device. In one embodiment, the client-side personal warning apparatus 210 is embodied as a widget on a widget enables television.

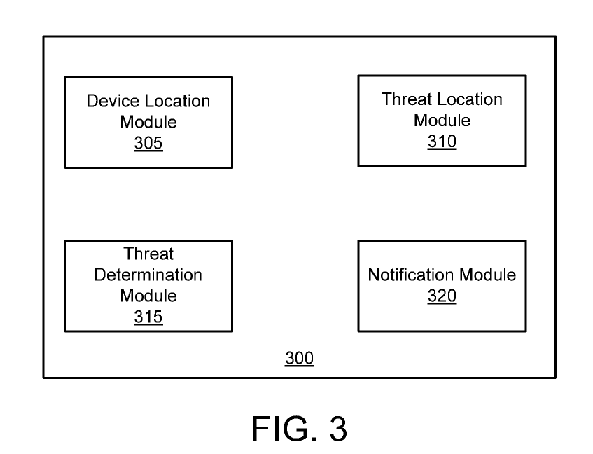

FIG. 3 depicts one embodiment of a personal threat notification apparatus 300 in accordance with the present subject matter. The apparatus 300 may comprise one embodiment of the personal warning apparatus 205 and/or the client-side personal warning apparatus 210. Specifically, all or a portion of one or more of the modules in the apparatus 300 may reside in the personal warning apparatus 205, the client-side personal warning apparatus 210, and/or both. The description of the apparatus 300 refers to elements of FIGS. 1-2, like numbers referring to like elements. The apparatus 300 includes one or more of a device location module 305, a threat location module 310, a threat determination module 315, and a notification module 320.

The device location module 305, in one embodiment, determines locations of devices 140. These devices 140 may be similar to and/or embodiments of the client device 140 depicted in FIGS. 1-2. In one embodiment, the devices 140 are registered devices 140 as described above. Characteristics and features of the device location module 305 discussed in relation to a single device 140 hereafter may also apply to a plurality of devices 140.

In one embodiment, the device location module 305 determines a device location comprising a geographic location of the device 140. In certain embodiments, the device location includes latitude and longitude coordinates or other suitable location coordinates. In one embodiment, the device location includes an altitude coordinate.

In one embodiment, the device location module 305 determines the device location by identifying a location of a nearest data source to the device 140 such as the nearest cellphone radio tower, the nearest Local Area Network (“LAN”) or Wireless Local Area Network (“WLAN”) connection on which the device 140 communicates, and/or the like. For example, the device location module 305 may determine the device location of a widget-enabled television based on geographic information of the WLAN in communication with the television.

In one embodiment, if the device 140 is a cellphone, the device location module 305 may determine the device location using multilateration of radio signals between a plurality of cellphone radio towers (e.g. cellphone triangulation). Specifically, by comparing the relative signal strength from multiple cellphone towers, a location of a cellphone may be approximated. In one embodiment, the device location module 305 may interface with a cellphone service provider for the device 140 and retrieve and/or reference location data obtained from cellphone triangulation. In one embodiment, the device location module 305 determines the device location of a device 140 according to the Secured User Place Location (“SUPL”) protocol/method from the Open Mobile Alliance (“OMA”) or the Control Plane protocol/method by 3rd Generation Partnership Project (“3GPP”).

In one embodiment, the device location module 305 determines the location using a Global Positioning System (GPS) if the device 140 includes a GPS receiver. A GPS receiver allows a device 140 to be tracked by satellite and enables the device 140 to communicate location to the device location module 305. The device location module 305 may use other suitable methods for determining the device location.

In one embodiment, the device location module 305 may be configured to use a plurality of device locating methods and/or may be configured to use a first available device locating method in a hierarchy of device locating methods (e.g. if GPS locating is available, the device location module 305 uses GPS or uses another method lower in the hierarchy if GPS is not available).

The device location module 305, in one embodiment, stores an entry in a database, flat file, or other suitable storage format. The entry may include the device location at a particular moment in time (e.g. the device location module 305 stores a timestamp along with the device location). In some embodiments, the device location module 305 stores other information along with the device location. In one embodiment, if the device 140 is powered off (e.g. a cellphone is turned off), the device location module 305 determines that the last known location when the device 140 was active is the device location.

In one embodiment, the device location module 305 determines the device location at predetermined intervals. In one embodiment, the predetermined interval is one minute, although other suitable intervals may be used.

The device location module 305 may continuously determine locations of registered devices 140 at predetermined intervals and/or receive notifications to determine locations of devices 140. For example, in one embodiment, the device location module 305 receives a signal to determine the device location in response to the threat determination module 315, described below, making an initial determination that a threat is within a predetermined distance of the device 140. In one embodiment, the device location module 305 is signaled to determine a device location when a vector of the device 140 is determined to intersect a vector of a threat as described below.

In one embodiment, the device location module 305 also determines vectors of devices 140. Specifically, in one embodiment, the device location module 305 determines a vector of a particular device 140 (a “device vector”) in which the device location module 305 had previously determined a device location. A vector includes a location and a magnitude representing velocity (speed and direction). The device location module 305 may determine a device vector based on speed of a device 140, direction of the device, and a current location of the device. The device location module 305, in one embodiment, determines a device's 140 speed using past entries for the device 140 (e.g. entries stored by the device location module 305) referenced from storage. For example, the device location module 305 may calculate a distance between two locations in the previous two entries and determine a speed of the device 140 based on the length of time between the two previous entries. The device location module 305 may calculate the distance between the two most recent locations (e.g. stored in storage 130) and divide the distance by the time interval between the two locations (obtained by referencing time stamps associated with each of the two locations in the entries). In one embodiment, the device location module 305 references and/or obtains a speed of the device 140 from a GPS application, such as one for a GPS device on the device 140. The device location module 305 may also use past location entries to determine a direction of the device 140, extrapolating a direction based on coordinates of the past locations. The device location module 305, in one embodiment, references highways and common routes of travel in determining a vector of the device 140 (e.g. direction may be assumed if the device 140 is traveling on a common highway).

In one embodiment, the device location module 305 determines a vector of a device 140 after a determination is made that threat is within a predetermined distance of the device location as described below.

In one embodiment, the device location module 305 also determines device locations for devices 140 associated with a device 140. Specifically, if a device 140 is associated with a second device 140, as described below, the device location module 305 may determine a second device location (a geographic location of the second device 140) in determining whether a threat is within a predetermined location of the second device 140. The device location module 305 may also determine device vectors for associated devices 140 in a similar manner as described above.

The threat location module 310, in one embodiment, determines threat locations. Similar to the device location module 305, characteristics and features of the threat location module 310 discussed in relation to a single threat hereafter may also apply to a plurality of threats as the threat location module 310 may determine locations of multiple threats.

In one embodiment, the threat location module 310 determines a threat location. The threat location may comprise a geographic location of a threat. Threats may include natural threats such as, but not limited to, tornados, thunder storms, flash floods, tsunamis, lightning, earthquakes, forest fires, and/or the like. Threats may include other threats such as, but not limited to, crimes, food poisoning events, radiation, Amber Alerts, and/or the like. Threats may include ground threats (e.g. earthquakes, HAZMAT, gang activity, and the like) and atmospheric threats (e.g. severe weather, lightning, thunderstorms, and the like). The threat location module 310 may determine threat location by referencing threat data, which includes an identification of a threat, location information of a threat, and/or other characteristics of a threat. Threat data may be stored in storage 130 in communication with the apparatus 300 and/or may be streamed from other servers such as third party servers. As described below, threat data may be referenced and/or collected from threat data collections, such as data files, provided by various sources such as government repositories, private repositories, and/or the like.

In one embodiment, the threat location module 310 references threat data and threat data collections in the form of shapefiles. Shapefiles are collections of data in a geospatial vector data format developed and regulated by the Economic and Social Research Institute (“Esri”). Storms and other weather phenomenon may be stored as a polygon using shapefiles along with geographic location data. Shapefiles may be interoperable with various GIS systems and may provide information for presenting a visual representation on a GIS map of the subject of the shapefiles (e.g. a storm).

In one embodiment, a threat is represented by a collection of shapefiles including a file describing the shape of the polygon (*.SHP), a file describing the data attributes of the data (*.DBF), an index file relating the other two files (*.SHX), and a file (*.PRJ) for alignment with other geographical data files. Shapefiles may specify latitude and longitude coordinates of the polygon representing the threat, as well as a vector of the threat (speed and a direction).

In one embodiment, the threat location module 310 references shapefiles for tornado warnings (TOR.SHP, TOR.DBF, TOR.SHX, TOR.PRJ), Severe Thunderstorm Warnings (SVR.SHP, SVR.DBF, SVR.SHX, SVR.PRJ), Flash Flood Warnings (FFW.SHP, FFW.DBF, FFW.SHX, FFW.PRJ) and/or Special Marine Warnings (SMW.SHP, SMW.DBF, SMW.SHX, SMW.PRJ), although the threat location module 310 may reference shapefiles for any suitable threats.

In one embodiment, the threat location module 310 references other threat data collections including threat data for other threats such as lightning. In one embodiment, the threat location module 310 references lightning strike data that includes a timestamp and latitude and longitude for each lightning strike. The threat location module 310 may reference still other threats in a variety of data formats stored in storage and/or stored on other servers including third-party servers and/or government servers.

In one embodiment, the threat location module 310 determines the threat location by referencing location information (e.g. latitude and longitude coordinates) in threat data for a threat (e.g. a shapefile).

The threat location module 310 may continuously determine locations of threats at predetermined intervals (e.g. every 1 minute or other suitable interval). In one embodiment, the threat location module 310 determines a location of a threat substantially at a same time that the device location module 305 determines a device location. In one embodiment, the threat location module 310 receives notifications to determine threat locations. For example, in one embodiment, the threat location module 310 receives a signal to determine the threat location in response to the threat determination module 315, described below, making an initial determination that a threat is within a predetermined distance of the device 140. In one embodiment, the threat location module 310 is signaled to determine a threat location when a device vector of the device 140 is determined to intersect a threat vector of a threat as described below.

In one embodiment, the threat location module 310 determines vectors of threats. Specifically, in one embodiment, the threat location module 310 determines a vector of a particular threat (a “threat vector”) in which the threat location module 310 had previously determined a threat location. The threat location module 310 may determine the threat vector by referencing vector information in threat data. For example, the threat location module 310 may reference a threat vector from shapefiles. In certain embodiments, the threat location module 310 calculates a threat vector based on past locations of the threat at certain times (extrapolating a vector using speed of the threat and location data). In one embodiment, the threat location module 310 determines a threat vector after a determination is made that threat is within a predetermined distance of the device 140.

As stated above, devices 140 may be associated with other devices 140 and receive notifications if threats are near the other devices 140. In one embodiment, the threat location module 310, in one embodiment, determines threat locations that pertain to associated devices 140 (second threat locations) as described below. The threat location module 310 may also determine threat vectors that pertain to associated devices 140 in a similar manner as described above.

The threat determination module 315, in one embodiment, determines whether the threat location is within a predetermined distance of the device location. As used herein, a threat determination refers to the threat determination module 315 determining whether a threat location is within a predetermined distance of a device location, and in some embodiments, then determining whether a threat vector of the threat intersects with a device vector of the device as described below. An instance in which the threat location is within the predetermined distance of the device location and the vectors intersect may be referred to herein as a positive threat determination.

In one embodiment, the predetermined distance comprises a radius around the device 140. In one embodiment, the predetermined distance is a twenty-mile radius around the device 140. In other embodiment, other suitable distances may be used. In one embodiment, the user may select a predetermined distance. In one embodiment, the threat determination module 315 uses a first predetermined distance for an initial threat determination and uses a second predetermined distance for a subsequent threat determination. For example, the threat determination module 315 may determine that a threat is within a 20 mile radius of the device 140 and the user may request an additional notification if the threat gets closer. The threat determination module 315 may then determine whether the threat is within a 5-mile radius of the device 140 at a later time.

In one embodiment, the threat determination module 315 determines whether the threat location is within the predetermined distance of the device 140 by calculating a distance between the latitude and longitude coordinates of the device location and the latitude and longitude coordinates of the threat (e.g. with the Pythagorean Theorem or the Great Circle Calculation). In certain embodiments, the threat determination module 315 calculates a distance between a threat and a device 140 using a GIS system, a map overlay with the GIS system—overlaying a map having the threat and a map having the device 140, and/or the like.

In one embodiment, the threat determination module 315 determines whether the threat is within the predetermined distance of the device 140 at regular intervals (e.g. every 1 minute or other suitable interval). In certain embodiments, the threat determination module 315 determines whether the threat is within the predetermined distance after the device location module 305 has determined a device location and after the threat location module 310 determines a threat location using the locations determined by each module.

In one embodiment, the threat determination module 315 signals the device location module 305 and the threat location module 310 to repeat determining their respective locations in response to determining that the threat location is within the predetermined distance of the device location. The threat determination module 315 may receive updated locations of the threat and the device 140 and make another determination of whether the threat is within the predetermined distance of the device 140 before calculating whether the vector of the threat intersects with the vector of the device 140 and/or presenting the device 140 with a notification. As a result, if the threat has shifted in position outside of the predetermined area, the user is spared an unnecessary notification because the threat determination module 315 makes another check.

In one embodiment, the threat determination module 315 determines whether a device vector intersects with the threat vector. The threat determination module 315 may reference the device vector and the threat vector and calculate whether the vectors intersect and an intersection location (e.g. latitude and longitude coordinates). In certain embodiments, the threat determination module 315 uses vector algebra to determine whether the device vector intersects with the threat vector as will be apparent to one of ordinary skill in the art in light of this disclosure. In one embodiment, the threat determination module 315 may determine whether two vectors intersect using the following equations:

L1=P1+a V1

L2=P2+b V2

L1 and L2 each represent lines. P1 and P2 are points on each line. V1 and V2 are the direction vectors for each line. The variable (a) represents the device 140 and (b) represents the threat. If the lines intersect, a point on L1 satisfies the equation for L2. If the lines are parallel, then there is no intersection. Therefore, the equations may be written as P1+a V1=P2+b V2, then a V1=(P2−P1)+b V2, then take the cross product of each side with V2 to eliminate b and the equation becomes a (V1×V2)=(P2−P1)×V2 to obtain a value for a that may be input into the equation for L1 to find the intersection point.

The intersection point becomes the target which (a) is moving towards. Back timing this according to (a), V1 indicates how much time the device (a) has until intersection (result) is reached. If (a) is moving towards the intersection at 60 mph, and the result is 60 miles away, then the ‘time’ away from intersection is 60 minutes (1 hour).

In one embodiment, if the threat determination module 315 determines that the device vector intersects the threat vector, the threat determination module 315 determines an intersection time of the device vector and the threat vector. The threat determination module 315, in one embodiment, determines the threat intersection time based on the speed of the threat and the speed of the device 140 and how long it will take each to reach the intersection point, giving the threat determination module 315 the time until the threat reaches the device 104. In one embodiment, the threat determination module uses this intersection time to determine the hours, minutes, and seconds until the threat reaches the device 140.

In one embodiment, the threat determination module 315 determines whether the threat vector and the device vector intersect after the threat determination module 315 determines that the threat location is with in the predetermined distance of the device location. In one embodiment, if the threat determination module 315 determines that the threat vector and the device vector intersect, the threat determination module 315 qualifies and/or classifies the threat (e.g. classifies the threat as a tornado warning).

In certain embodiments, the threat determination module 315 determines whether threat locations are within predetermined distances of associated devices 140. As described below, a user may associate other devices/users with the user's device 140 and/or user account. The threat determination module 315 may determine whether any of a user's associated devices 140 are within a predetermined distance of a threat. In one embodiment, the threat determination module 315, after making a threat determination for a device 140, then makes threat determinations for each of the associated devices 140 of the device 140.

The notification module 320, in one embodiment, presents a notification to the device 140 regarding a threat. Presenting the notification may include sending or transmitting the notification to the device 140. Presenting the notification may also include displaying or causing to display the notification on the device 140. In one embodiment, the notification module 320 presents the notification in response to the threat determination module 315 determining that a threat location is within a predetermined distance of a device location and/or in response to the threat determination module 315 determining that a threat vector intersects a device vector. In one embodiment, the notification module 320 presents the notification in response to the threat determination module 315 making a plurality of determinations that the locations are within the determined distance and/or that the vectors intersect. For example, in one embodiment, the threat determination module 315 makes an initial determination, which if positive (e.g. the locations are within the predetermined distance and/or the vectors intersect), causes the threat determination module 315 to “check again” and make another determination that the locations are within the predetermined distance and/or the vectors intersect before signaling the notification module 320 to present the notification.

The notification module 320, in one embodiment, presents the notification by sending a message to the device 140, triggering a message in the device 140 (e.g. causing a pop-up in a web browser, an appearance of an application window, and/or the like). The notification may be embodied by a message in a web browser, an application window, a message inserted into a GPS program on the device 140, and/or other visual manifestation on a user interface of the device 140. The notification may also be a text message, a phone call with a recorded message, and other suitable notification forms. In one embodiment, a form of the notification depends on a form of communication that the notification module 320 used to communicate the notification. In one embodiment, the notification module 320 sends a notification to a device 140 using a plurality of forms of communication. For example, the notification module 320 may send a text message, trigger a notification in an application on the device 140, and/or the like in case a threat has disabled certain forms of communication.

The notification may include information about the threat including an identification of the threat, an intersection time (e.g. an estimated time of intersection of the threat with the device 140), an option for the user to view more information, a suggestion (e.g. “seek shelter”), and/or the like. In one embodiment, the notification may include suggestions related to affiliated advertisers. For example, if a particular restaurant is an advertiser and is nearby, the notification module 320 may suggest the particular restaurant as an option for shelter. As described below, the notification may trigger the device 140 to search for a localized radio signal of a local entity. The device 140 may present an advertisement and/or a suggestion related to the local entity in response to locating a localized radio signal.

The notification may include one or more images, videos, and/or animations with a map of the device location and the threat location. The notification may also include and/or trigger on the device 140, a countdown that counts down time until the intersection of the threat with the device 140. In one embodiment, the notification includes an option for the user to request an additional notification if the threat falls within another predetermined distance (e.g. a short distance than the initial predetermined distance) of the device 140. For example, if the threat location is within 20 miles of the device 140, the notification module 320 may present a notification to the device 140 and the user may request an additional notification if the threat location comes to within 10 miles of the device 140.

The notification may also include an option for the user to dismiss the notification or to receive additional notifications showing updated locations of the threat. In one embodiment, the notification module 320 communicates additional notifications to associated devices 140 that are associated with (e.g. “following”) a particular device 140 when the user of the particular device 140 acknowledges a notification. The additional notification to the additional devices 140 may indicate that the user has acknowledged the notification.

The notification module 320, in one embodiment, presents notifications to a device 140 for its associated devices 140. In one embodiment, the notification module 320 presents a notification to a device 140 in response to determining that a threat location is within a predetermined distance of an associated device 140 (a “second device”) and/or when the device vector intersects with the threat vector. Therefore, a user may be alerted when other devices/users that the user is following are potentially in harm's way. In one embodiment, the notification module 320 presents a notification to a device 140 in response to a user of an associated device 140 acknowledging a threat notification. For example, if User A is following User B and User B is within the predetermined distance of a threat, User A and User B may both receive notifications that User B is within the predetermined distance of the threat. User B may acknowledge the notification and the notification module 320 may send User A an additional notification that User B has acknowledged the notification.

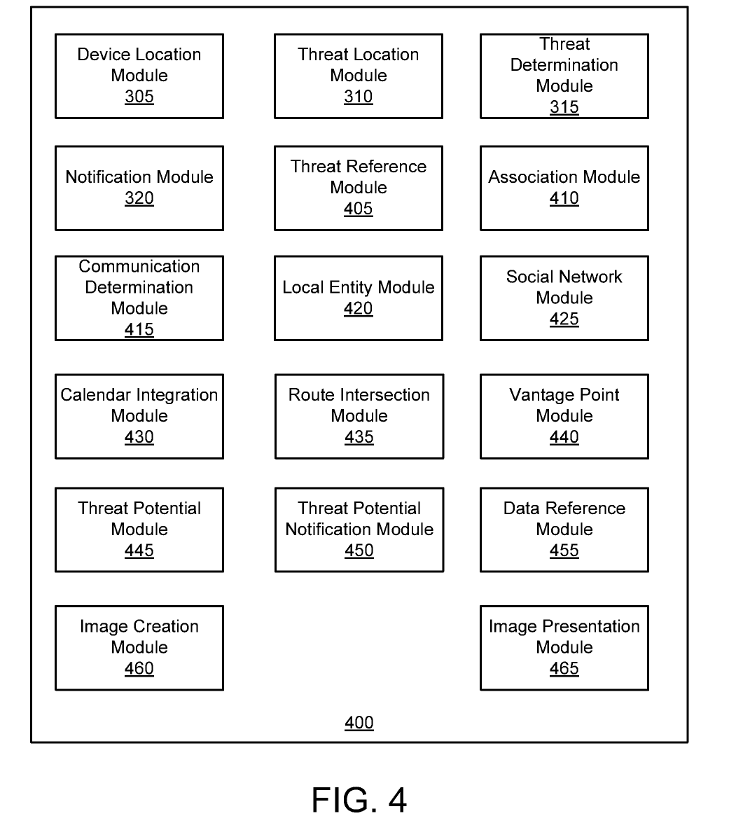

FIG. 4 depicts another embodiment of a personal threat notification apparatus 400 in accordance with the present subject matter. The apparatus 400 may comprise one embodiment of the personal warning apparatus 205 and/or the client-side personal warning apparatus 210. Specifically, all or a portion of one or more of the modules in the apparatus 400 may reside in the personal warning apparatus 205, the client-side personal warning apparatus 210, and/or both. The description of the apparatus 400 refers to elements of FIGS. 1-3, like numbers referring to like elements. The apparatus 400 includes one or more of the device location module 305, the threat location module 310, the threat determination module 315, and the notification module 320, wherein these modules may be substantially similar to the like numbered modules in FIG. 3.

In addition, the apparatus 400 includes one or more of a threat reference module 405, an association module 410, a communication determination module 415, a local entity module 420, a social network module 425, a calendar integration module 430, a route intersection module 435, a vantage point module 440, a threat potential module 445, a threat potential notification module 450, a data reference module 455, an image creation module 460, and an image presentation module 465.

The threat reference module 405, in one embodiment, references a plurality of threat data collections for a plurality of threats. The threat location module 310, as described above may determine threat locations of threats based on data for the threats in one or more of the threat data collections. The threat reference module 405 may reference, obtain, download, and/or collect threat data from threat data collections, such as data files, provided by various sources such as government repositories, private repositories, and/or the like. As described above, threat data may be obtained in the form of shapefiles for a variety of threats. In one embodiment, the threat location module 310 downloads threat data collections into storage and parses the threat data collections, storing threat data into one or more databases. The threat reference module 405 may obtain and/or access threat data through APIs provided by certain government servers and/or government websites such as www.nws.noaa.gov/regsci/gis/shapefiles/.

The association module 410, in one embodiment, associates additional devices 140 with a device 140 and/or users with additional users, allowing a user to “follow” other users. In one embodiment, the association module 410 associates a plurality of second devices 140 with a device 140 such that the device 140 may receive notifications that pertain to each of the second devices 140. The association module 410 allows a user to receive notifications when other users come into proximity with a threat. Specifically, in one embodiment, the association module 410 associates a second device 140 with a device 140. The association module 410 may associate the second device 140 with the device 140 by associating a user profile for a user of the device 140 with a user profile of a user for the second device 140. In one embodiment, the association of users extends to each device 140 registered by a user. For example, if the association module 410 creates an association between User A and User B and User A has two registered devices 140 and access to the social networking module through User A's account, User A may receive notifications when User B is near a threat on both of User A's devices 140 and through the user interface of the social networking module.

A user of the device 140 may initiate the association through the user's user profile. For example, the user may select additional users to follow through the social network application module described below. The association module 410 may associate a registered device 140 of an additional user with the device 140 of the user in response to the additional user accepting an association request of the user for the user to follow the additional user. In one embodiment, the association module 410 verifies an association request. For example, a user requesting association with an additional user may be asked for information such as a relationship with the additional user or other personal information such as an email address of the additional user, a phone number and/or the like. For example, the association module 410 may associate a father's user profile with a son's user profile in response to the father providing additional information such as, but not limited to, a cellphone account number for the son's cellphone.

The association between a device 140 and a second device 140 may allow for two-way notifications. For example, User A may be notified when User B is near a threat and vice-versa. In one embodiment, the association allows for one-way communication (e.g. User A is notified when User B is near a threat, but User B is not notified when User A is near a threat). In one embodiment, a user may specify different notification characteristics for each other user/device 140 that the user is following. Notification characteristics may include, but are not limited to, a priority, certain threats to be notified of, a predetermined distance of the threat (e.g. User A wants to be notified when a threat is within 10 miles of User B but wants to be notified when a threat is within 20 miles of User C), and the like.

An associated device 140 may be a cellphone or other device 140 as described above. In one embodiment, an associated device 140 is a GPS device, RFID transmitter, and/or a local transmitter. In certain embodiments, the association module 410 makes a temporary association of a device 140 with a second device 140. For example, a user may request a temporary association of a device 140 with a transmitter device 140 for a day while the user is at a theme park. The association module 410 may create the temporary association, which will expire after a certain time period (e.g. a day).

The association module 410 may create an association by recording an entry in a database. For example, a database managed by the apparatus may provide a field for users and/or devices 140 in which a particular user is following and the association module 410 may add a device 140 and/or user identifier into the field for the particular user.

The communication determination module 415, in one embodiment, determines a first available communication option of a hierarchy of communication options for communicating with the device 140. A communication option, as used herein, refers to a method of communication, a communication format, a communication protocol, and/or the like. Non-limiting examples of communication options include, but are not limited to, data transfer over 4th generation (“4G”), 4th generation Long Term Evolution(“4GLTE”), 3rd Generation Partnership Project (“3GPP”), and/or 3rd generation (“3G”) mobile telecommunications standards, Internet communications, Short Message Service (“SMS”), a telephone call, e-mail, instant messaging, and/or other suitable communication options. The notification module 320, in one embodiment, sends the notification to the device 140 using the first available communication option. For example, the protocol determination module may have a list of communication options in hierarchical order of preference. The communication determination module 415 may use a first available communication option by attempting communication with and/or determine availability of each communication option in the list of communication options starting with the communication option of the highest priority until successful communication is achieved with a particular communication option. In one embodiment, the communication determination module 415 determines availability of communication options by referring to device specifications for a user's device 140 to see what communication options the device 140 can support, by attempting communication using a particular communication option and determining whether the communication was successful, according to user preference, and/or the like.

In one embodiment, the hierarchy of communication options differs with each device 140, with each user, is specified by user preference, and/or the like. The hierarchy of communication options may also vary if affected by certain threats (e.g. a tornado may disable certain communication options).

The local entity module 420, in one embodiment, initiates a local entity search on a device 140. As mentioned above, certain entities local to a device 140 may transmit local wireless transmission signals. The device 140 may receive a signal from the local entity module 420 to initiate a local entity search, which is an attempt to discover any local communication signals (e.g. radio signals) in range of the device 140. The device 140 may detect a local wireless transmission signal and displays a presentation associated with the local wireless transmission signal in response to initiating a local entity search on the device 140. The presentation may be an advertisement for the local entity, a suggestion that involves the local entity (e.g. a suggestion that a user seeks shelter in a particular restaurant), and/or the like. In one embodiment, the presentation is sent to the device 140 from the local entity module 420 (e.g. it is stored on storage) in response to the device 140 detecting the local wireless transmission signal and identifying it as belonging to a particular local entity. In one embodiment, the presentation is transmitted as part of the wireless transmission signal and the device 140 downloads and/or references the presentation as part of the wireless transmission signal. A local entity may obtain a wireless transmission device and register it with the local entity module 420. The wireless transmission device may be a GPS device, a Radio Frequency Identification (“RFID”) device, a WLAN, and/or the like.

The social network module 425, in one embodiment, provides a social networking platform to allow users to share information, view the status of other users, view threats, and/or the like. The social network module 425 may host, store, include and/or provide web-based social networking and/or a web-based social networking website for access over the network 135. In one embodiment, the social network module 425 integrates with a third-party social networking platform such as Facebook.

The social network module 425, in one embodiment, allows a user to view associated users and/or associated devices (those the user is following), manage device/user associations (e.g. make association requests, terminate associations, and the like), view maps displaying the user's device location, threat locations, and device locations of associated devices 140. The social networking module may display content from associated users. For example, a user's associated users may upload videos, text, photos, and the like. For example, a user may login to the social networking platform provided by the social network module 425 to view collaborative information (information from a plurality of users) regarding a specific threat. Other users may post videos of a storm, may describe conditions on the ground, and the like.

In one embodiment, the social network module 425 presents a social network interface to a device 140. The social network interface may be a web page on a web browser in the device 140, a plug-in to a web browser, an application that displays information and content from the social network module 425, and/or the like. In one embodiment, the social network module 425 presents and/or triggers the social network interface in response to a user requesting additional information on a threat as part of a notification. In one embodiment, a notification sent by the notification module 320 gives the user an option of requesting additional information and the social network module 425 displays collaborative information (information from a plurality of users) associated with the threat in response to receiving the request for additional information. For example, the user may request additional information on a threat from a link or selection in the notification and the social network module 425 may launch a browser or other application in the device 140 to display a web page or other content from the social networking platform and the user may view collaborative information (e.g. videos, text, pictures) posted by others regarding the threat.

The calendar integration module 430, in one embodiment, communicates with, references, and/or integrates with one or more calendar applications. In one embodiment, the calendar integration module 430 provides information on threats past one hour based on where a device 140 may be located as determined by future events marked in the calendar applications. The calendar integration module 430 may include a plug-in to an existing calendar application or may include an interface with such applications. These calendar applications may include, but are not limited to, a Microsoft® Outlook® application, a Google® Calendar application, and/or other suitable calendar applications. The calendar application, in one embodiment, is provided by and/or hosted by the calendar integration module 430.

In one embodiment, the calendar integration module 430 determines an initial location. In one embodiment, the initial location is a location of a device 140. In another embodiment, the initial location is a location (a “first event location”) of an event (a “first calendar event”) referenced from the user's calendar application. Specifically, in this embodiment, the calendar integration module 430, in determining the initial location, references a first calendar event from the calendar application. The first calendar event may include a first event time. In one embodiment, the calendar integration module 430 references a second calendar event. The second calendar event may also be referenced from the user's calendar application. The second calendar event may include a second event location and a second event time.

The calendar integration module 430 may determine the first and second event locations using addresses entered into calendar entries for the first and second events respectively. In one embodiment, if a place is named in relation to an event (e.g. a name of a particular restaurant), the calendar integration module 430 may look up a location corresponding to the place name and use that as an event location.

The route intersection module 435, in one embodiment, determines a route of travel from the first event location or the initial location and the second event location. The route intersection module 435, in one embodiment, comprises and/or interfaces with a GIS system, or other map application to determine the route of travel, including predicted roads and highways used in the route. The route of travel may be based on the first event time (or a current time or estimated departure time if the device 140 location is used) and the second event time. In one embodiment, the route intersection module 435 may determine the route of travel based on an estimated speed that the device 140 may travel to reach the second event location.

In one embodiment, the route intersection module 435 determines whether a threat may intersect the route of travel. The route intersection module 435 may reference predicted threat area data for a threat. In one embodiment, the predicted threat area data includes location coordinates (e.g. latitude and longitude coordinates) that define a polygon of a geographic area of a predicted threat, such as a storm (e.g. where the predicted movement of the storm). The route intersection module 435, in one embodiment, references the predicted threat area data from a threat repository as described above. In one embodiment, the route intersection module 435 references the predicted threat area data from the United States National Weather Service repository (http://www.spc.noaa.gov) or other suitable weather database. If the route intersection module 435 determines that the polygon for the predicted threat intersects with the route of travel during the expected time frame (e.g. the latitude and longitude coordinates of the predicted threat overlap the latitude and longitude coordinates of the route of travel), in one embodiment, the notification module 320 presents a notification to the device 140. The notification may include a description of the threat, instructions on what supplies to bring, what clothing to wear, a weather forecast, a calculation of the conditions during the journey, an opinion of whether the journey may be safe, and/or the like. The notification may also provide an option for the user to receive an update as the second event time gets closer. The route intersection module 435 may re-determine the route of travel at a predetermined time before the second event time and may signal the notification module 320 to send an updated notification with updated information on the threat.

The vantage point module 440, in one embodiment, determines a vantage point of a device 140. The vantage point of the device 140, in one embodiment, is an approximation and/or simulation of a point of view of the device 140. In one embodiment, the vantage point module 440 approximates a vantage point of a camera on the device, or what a camera would view if a camera were on a device. For example, if the front of the device 140 is facing the ground, the vantage point module 440 may determine that the vantage point is a view of the ground when in the same location, if the front of the device is pointing up, the vantage point module 440 may determine that the vantage point is a view of the sky. The vantage point of the device 140 may include a viewing angle, viewing dimensions including height and width, field of view, and the like. The vantage point may include a location of the device 140. In one embodiment, the location includes latitude and longitude coordinates or other suitable location coordinates. In one embodiment, the location includes altitude.

The vantage point module 440, in one embodiment, determines a vantage point of a device 140 by determining a device location in a similar fashion as the device location module 305 described above. The vantage point module 440 may determine an altitude of the device 140 by referencing a known altitude at a particular location, retrieving altitude information from the device 140 if the device is GPS enabled, and/or the like. The vantage point module 440 may determine the viewing angle by referencing accelerometer data for an accelerometer in the device 140. In certain embodiments, the device 140 may have an accelerometer whose data, indicating movement and position in space, is available by way of an API of the accelerometer. In one embodiment, the vantage point module 440 determines, assigns, and/or considers a particular surface of the device 140 as a vantage point surface. The vantage point surface may determine the vantage point. For example, if the vantage point module 440 determines that a phone back (e.g. a side of a phone opposite a screen, buttons, and the like) is the vantage point surface, the vantage point module 440 may determine the vantage point as if looking from the phone back.

In one embodiment, a user may trigger the vantage point module 440 by taking a picture with the user's device 140. For example, the user may request a vantage point determination and then take a picture and the vantage point module 440 may determine the vantage point based on the vantage point of the device at the time the picture was taken.

The threat potential module 445, in one embodiment, determines a threat potential of a potential threat element in the vantage point. A potential threat element refers to an object in the vantage point. In one embodiment, a potential threat element is an object in the vantage point that may potentially correspond to threat data, be represented by threat data, or may be classified by threat data. For example, a potential threat element may be a cloud, which may be represented by threat data if the cloud is part of a severe storm, a building, which may be represented by threat data if the building is mentioned in a police bulletin, a wave, which may be represented by threat data for potential tsunami hazards, and the like. In one embodiment, the threat potential module 445 identifies the threat potential of any potential threat elements in the vantage point by referencing data of the vantage point including a device location, device altitude, and the viewing angle. The threat potential module 445, in one embodiment, determines geographic coordinates of an area of the vantage point based on the device location, device altitude, and the viewing angle. The threat potential module 445 references threat data to determine whether any threats exist in the area of the vantage point. In one embodiment, the threat potential module 445 represents the area of the vantage point as a polygon and determines whether polygons of threats intersect with the polygon of the area of the vantage point.

In one embodiment, the threat potential module 445 identifies a potential threat element as unsafe if the potential threat element corresponds to a threat. In one embodiment, if the polygon of a threat and a polygon of the area of the vantage point intersect, the threat potential module 445 may identify a potential threat element as unsafe. In one embodiment, the threat is referenced from a threat data (e.g. a shapefile or other threat data) as described above. If the potential threat element does not correspond to a threat (e.g. no threats are identified in the area of the vantage point), the threat potential module 445 may identify a potential threat element as safe.

The threat potential notification module 450, in one embodiment, presents a notification to the device 140. In one embodiment, the notification includes the threat potential of the potential threat element. Specifically, the notification may indicate whether the potential threat element is safe or not safe. In one embodiment, if the user triggered the vantage point module 440 by taking a picture with the user's device, the notification may include the image of the picture along with information on the potential threat, such as whether the potential threat element is “safe” (e.g. it does not correspond to threat data) or “unsafe” (e.g. it corresponds to threat data). The threat potential notification module 450 may present notifications using similar communication forms as the notification module 320 described above. Presenting the notification may include sending or transmitting the notification to the device. Presenting the notification may also include displaying or causing to display the notification on the device.

In certain embodiments, a rendered atmospheric image of a potential threat element and/or a vantage point may be presented to the user's device 140. Consequently, the apparatus 400 may include a data reference module 455 that, in one embodiment, references atmospheric data corresponding to the vantage point. Referencing may refer to obtaining, downloading, receiving, and/or the like. The atmospheric data may include atmospheric location data and atmospheric modeling data. Atmospheric location data refers to data related to geographic coordinates and location information of weather, threats, and/or the like. The data reference module 455 may reference shapefiles and other threat and/or weather data as described above to obtain atmospheric location data. Atmospheric modeling data refers to image data including two dimensional, three-dimensional and/or volumetric data and/or models on threats, weather, and other atmospheric features. In one embodiment, the data reference module 455 references three-dimensional visual data and/or models generated from the Doppler radars of the National Weather Service (“NWS”) or from other suitable sources. In one embodiment, the data reference module 455 references Doppler Radar layer images from the NWS. Each layer may comprise a two-dimensional “slice” of the atmosphere.

The image creation module 460, in one embodiment, creates one or more atmospheric images approximating the vantage point. In one embodiment, the image creation module 460 comprises, is integrated with, and/or communicates with a three-dimensional (“3D”) computer graphics modeling application. The one or more atmospheric images may be created from the atmospheric data. In one embodiment, the image creation module 460 creates the one or more atmospheric images from atmospheric data including existing three-dimensional visual data and/or three-dimensional (“3D”) models. In certain embodiments, the data reference module 455 generates a 3D model with the atmospheric data using the Doppler Radar layers obtained from the NWS. The data reference module 455 may obtain a plurality of layers, stack them, and construct a 3D model with 3D computer graphic processing using these stacked layers.

In one embodiment, the image creation module 460 uses a view reference point (a reference point of view) of the 3D model that approximates the vantage point. The view reference point may approximate the vantage point by approximating, to scale with the 3D model, a device's distance from the model, viewing angle, and/or the like. For example, if a cloud formation in the vantage point is ten miles away from the device, the image creation module 460 may approximate a similar distance from the 3D model of the cloud in the 3D modeling working area.

The image creation module 460 may capture and render one or more two-dimensional 2D images of the 3D model from a view reference point that approximates the vantage point toward the 3D model. The one or more images may include a single image, a video such as a 3D animation, and/or the like. The one or more images may depict Doppler Radar colors (e.g. reds, greens, blues) indicating characteristics of the atmosphere in the image.

The image presentation module 465, in one embodiment, presents the one or more atmospheric images to the device 140. Presenting the images to the device may include sending the images to the device, notifying the device of a link to the image on the Internet, providing the images on the social networking platform, and/or the like. In one embodiment, the image presentation module 465 includes the one or more atmospheric images along with a notification of whether the potential threat element is safe or not safe.

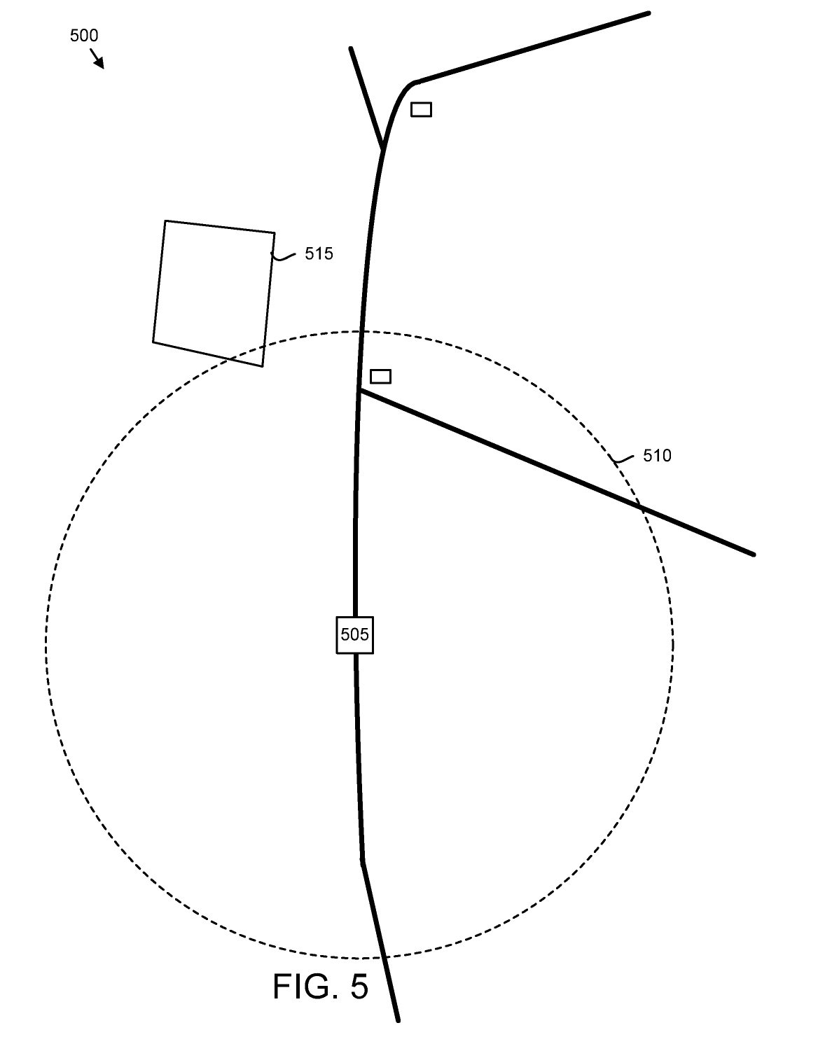

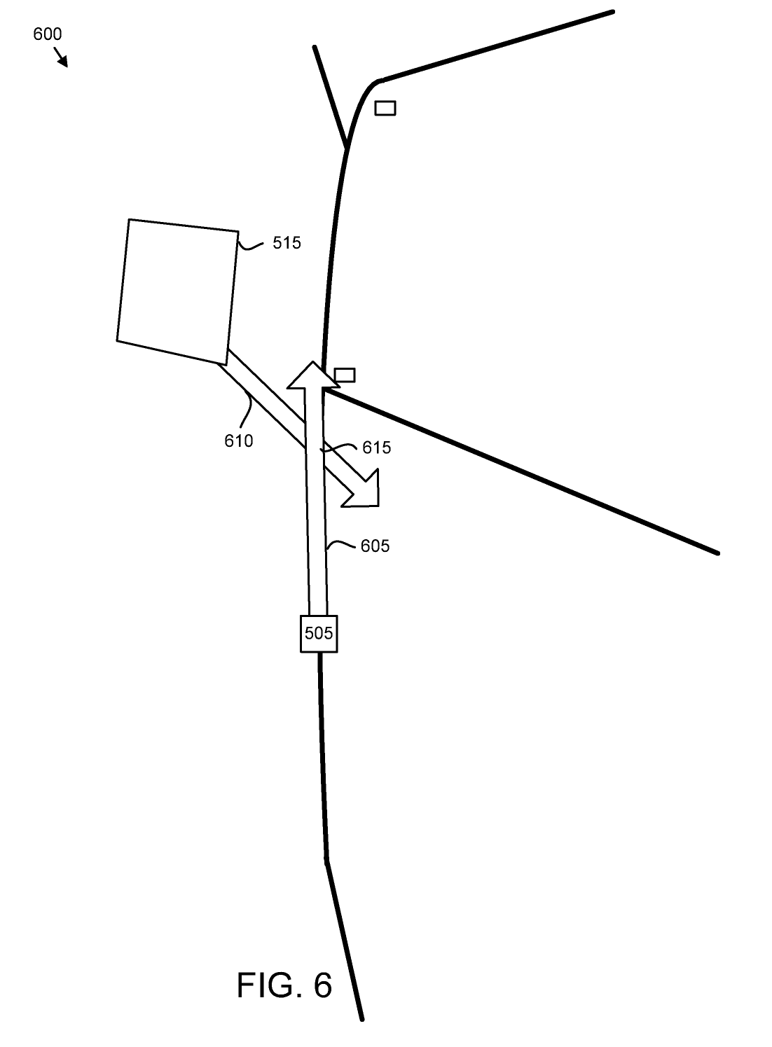

FIG. 5 depicts one embodiment of a map 500 showing a device 505 within a predetermined distance 510 of a threat 515 (as represented by a polygon). As described above, the notification module 320 may send a notification to the device 505 notifying the user of the threat 515. FIG. 6 depicts one embodiment of a map 600 showing the device vector 605 of the device 505 of FIG. 5 and a threat vector 610 of the threat 515 of FIG. 5. In the depicted embodiment, the device vector 605 and the threat vector 610 intersect. When the vectors 605, 610 intersect, in one embodiment, the notification module 320 presents a notification to the device 505 of the threat, including an intersection time and/or countdown to the intersection time.

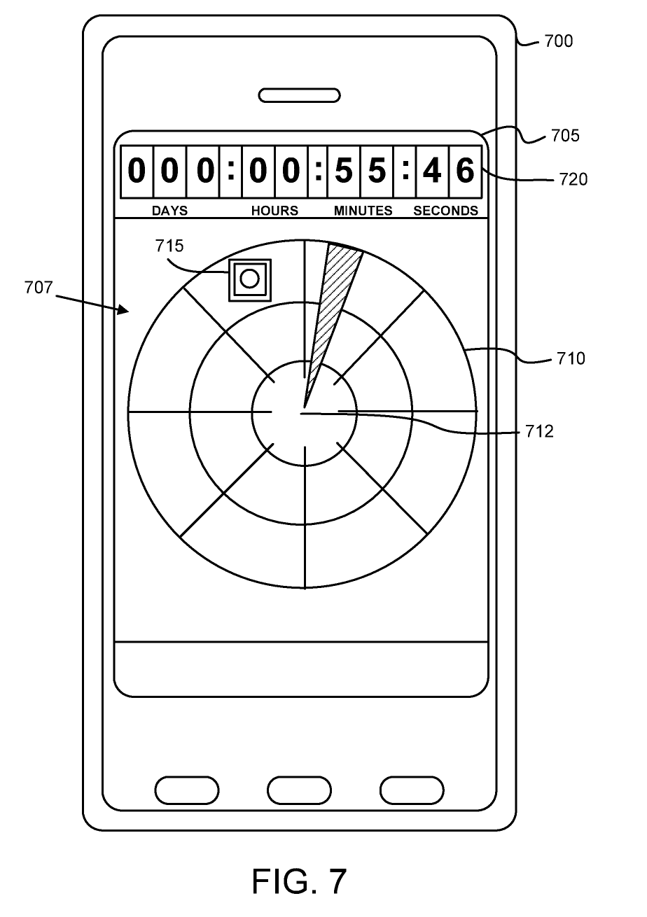

FIG. 7 depicts one embodiment of a display 707 showing a threat and an intersection time. The display 707, depicted on a screen 705 of a device 700, may be part of a user interface provided by the client-side personal warning apparatus 210. The device 700, in the depicted embodiment, is a Smartphone, although any suitable device may show the display 707. The display 707 includes a representation of a proximity 710 surrounding the device 700, which may be represented as being in the center 712 of the proximity 710. The proximity 710, in one embodiment, represents the predetermined distance as described above. The display 707 also includes a representation of the threat 715 and a countdown 720 with an amount of time until the threat 715 and the device 700 intersect 700.

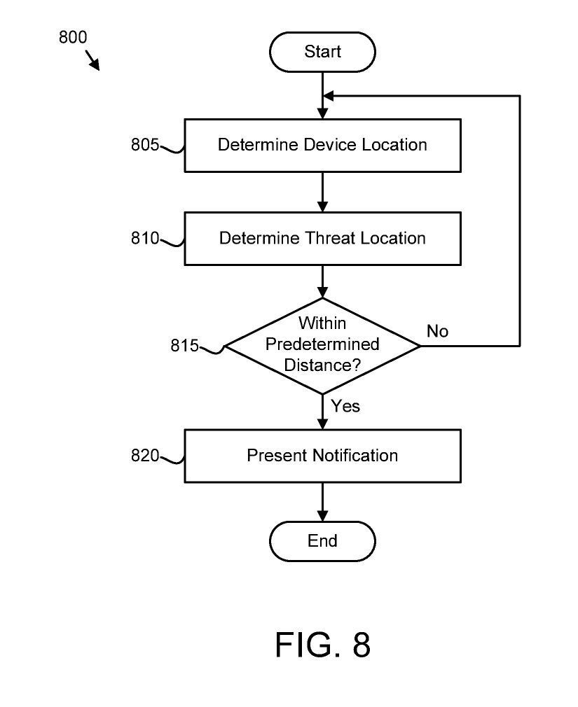

FIG. 8 depicts one embodiment of a personal threat notification method 800 in accordance with the present subject matter. The method 800 begins and the device location module 305 determines 805 a device location. The device location, in one embodiment, is a geographic location of a device 140. The threat location module 310 determines 810 a threat location that includes a geographic location of a threat. If the threat determination module 315 determines 815 that the threat location is not within a predetermined distance of the device 140 location, the method 800 returns to step 805 and continues with the device 140 location module 305 again determining 805 the device 140 location. If the threat determination module 315 determines 815 that the threat location is within a predetermined distance of the device 140 location, the notification module 320 presents 820 a notification to the device and the method 800 ends.

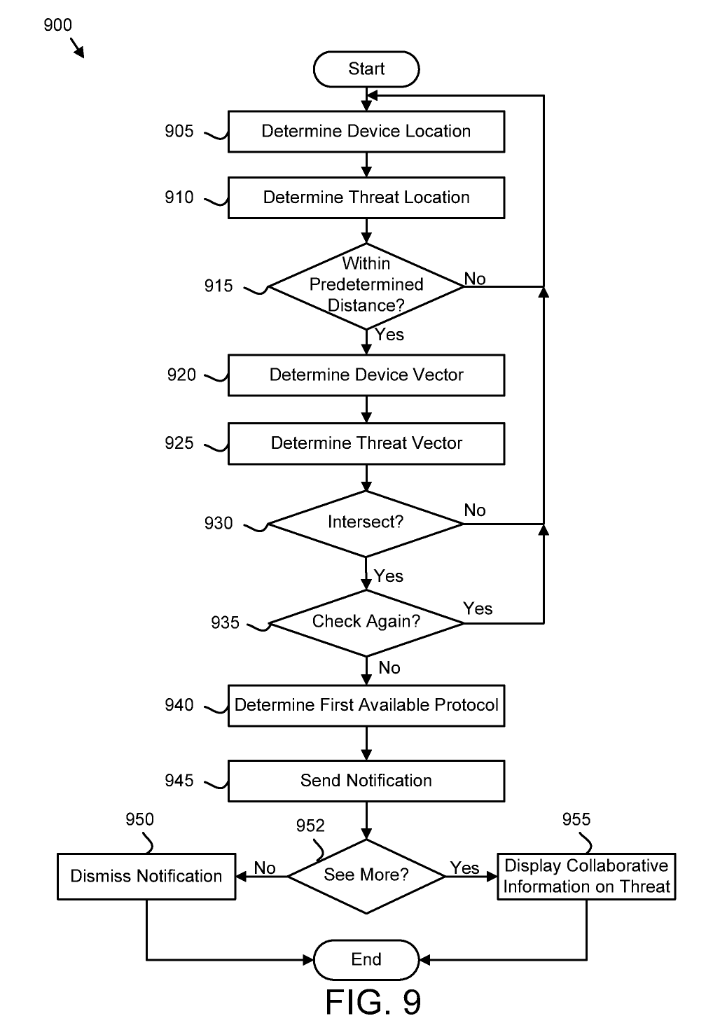

FIG. 9 depicts another embodiment of a personal threat notification method 900 in accordance with the present subject matter. The method 900 begins and the device location module 305 determines 905 a device location. The threat location module 310 determines 910 a threat location. If the threat determination module 315 determines 915 that the threat location is not within a predetermined distance of the device location, the method 900 returns to step 805 with the device location module 305 again determining a device location.

If the threat determination module 315 determines 915 that the threat 305 location is within a predetermined distance of the device location, the device location module 305 determines 920 a device vector. The threat location module 310 determines 925 a threat vector. The threat determination module 315 determines 930 whether the device vector intersects the threat vector. If the threat determination module 315 determines 930 that the device vector does not intersect the threat vector, the method 900 returns to step 805 with the device location module 305 again determining 905 a device location.

If the threat determination module 315 determines 930 that the device vector intersects the threat vector, the threat determination module 315 determines 935 whether another threat determination should be made (e.g. check again). In one embodiment, the threat determination module 315, upon an initial positive threat determination, initiates another threat determination and the method 900 returns to step 905 with the device location module 305 again determining 905 a device location.

The threat determination module 315 may determine that another check is not needed. In one embodiment, the notification module 320 presents a notification after two positive threat determinations have been made. Therefore, if the threat determination module 315 determines 935 that another check is not needed, such as if an initial positive threat determination has already been made, the communication determination module 415 determines 940 a first available communication option of a hierarchy of communication options for communicating with the device 140 and the notification module 320 sends 945 a notification to the device 140 using the first available communication option.

If the notification module 320 determines 952 that the user has selected to see more information on the threat, the social network module 425 displays 955 collaborative information associated with the threat, such as directing the user to the social networking platform and the method 900 ends. Alternatively, the notification module 320 dismisses 950 the notification and the method 900 ends.

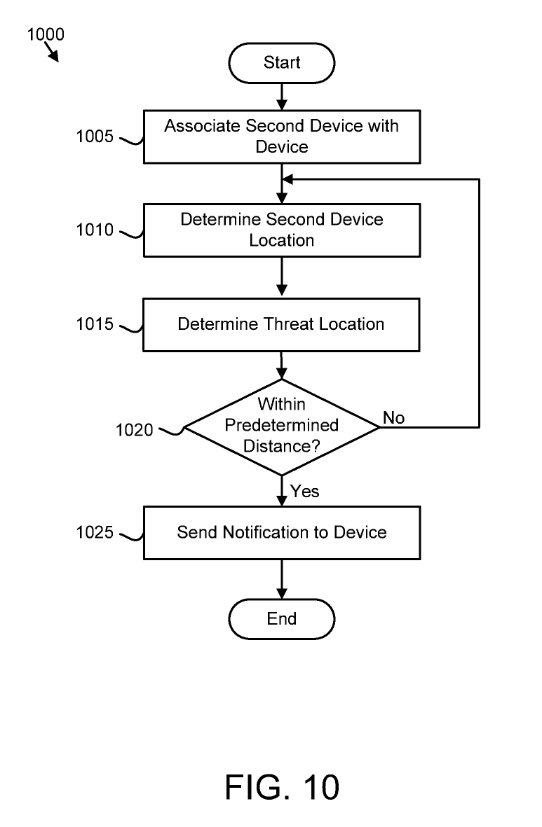

FIG. 10 depicts yet another embodiment of a personal threat notification method 1000 in accordance with the present subject matter. The method 1000 begins and the association module 410 associates 1005 a second device 140 with a device 140. The device location module 305 determines 1010 a device location of the second device 140 (“second device location”). The threat location module 310 determines 1015 a threat location of the second threat. If the threat determination module 315 determines 1020 that the threat location is not within a predetermined distance of the device location of the second device 140, the method 1000 returns to step 1010 with the device location module 305 determining 1010 the device location of the second device 140.

Alternatively, if the threat determination module 315 determines 1020 that the threat location is within a predetermined distance of the second device location, the notification module 320 sends 1025 a notification to the device 140. Then, the method 1000 ends.

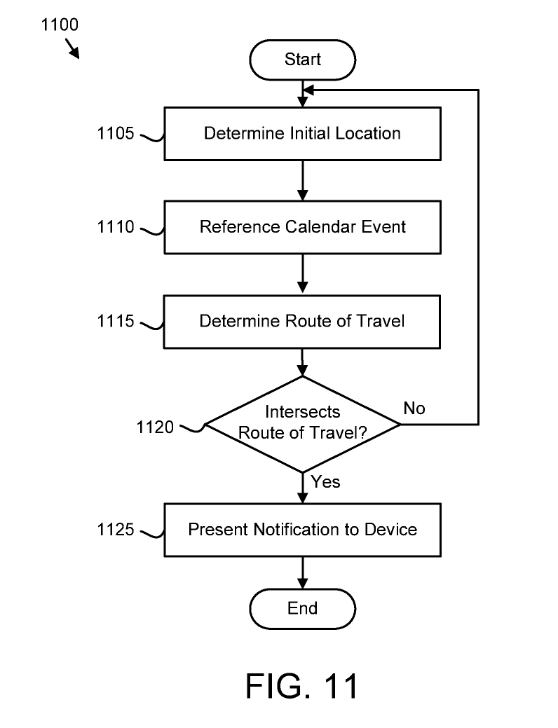

FIG. 11 depicts one embodiment of a personal threat notification method 1100 with calendar integration in accordance with the present subject matter. The method 1000 begins and the calendar integration module 430 determines 1105 an initial location. In one embodiment, the initial location is a location of a device 140. In another embodiment, the initial location is a first event location. Specifically, in this embodiment, the calendar integration module 430, in determining the initial location, references a first calendar event. The first calendar event may include the first event location and a first event time.

The calendar integration module 430 references 1110 a second calendar event. The second calendar event includes a second event location and a second event time. The route intersection module 435 determines 1115 a route of travel from the initial location and the second event location. If the route intersection module 435 determines 1120 that a threat intersects with the route of travel, the notification module 320 presents 1125 a notification to the device 140 and the method 1100 ends. Alternatively, if the route intersection module 435 determines 1120 that a threat does not intersect with the route of travel, the method 1100 ends.

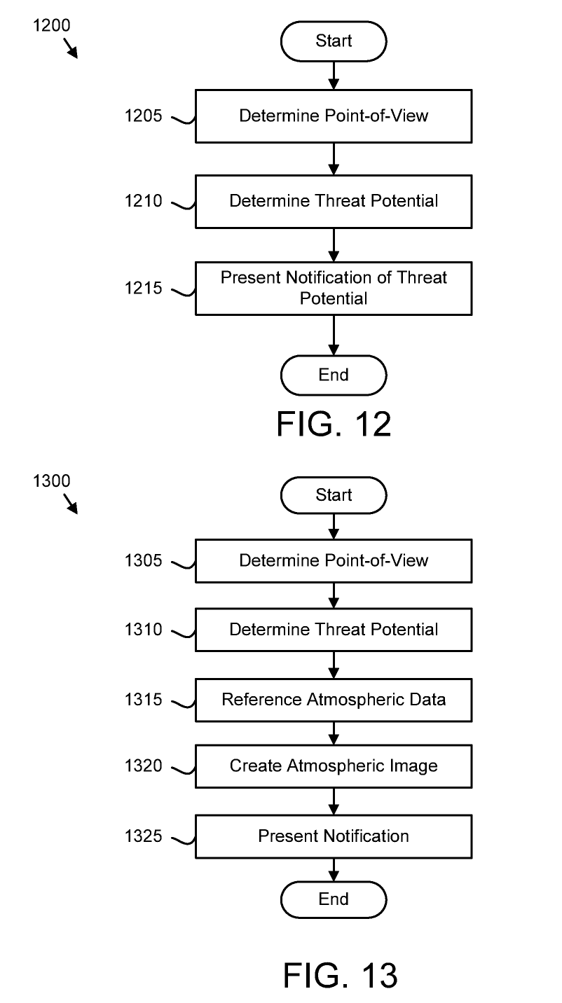

FIG. 12 depicts one embodiment of a method 1200 to determine a threat potential in accordance with the present subject matter. The method 1200 begins and the vantage point module 440 determines 1205 a vantage point of a device 140. The vantage point module may determine the vantage point in response to a user selection and/or in response to a user taking a picture with the user's device 140. The vantage point may include a location and a viewing angle. The threat potential module 445 determines 1210 a threat potential of a potential threat element in the vantage point. The threat potential notification module 450 presents 1215 a notification to the device 140 with the threat potential of the potential threat element. Then, the method 1200 ends.

FIG. 13 depicts another embodiment of a method 1300 to determine a threat potential in accordance with the present subject matter. The method 1300 begins and the vantage point module 440 determines 1305 a vantage point of a device 140. The vantage point may include a location and a viewing angle. The threat potential module 445 determines 1310 a threat potential of a potential threat element in the vantage point. The data reference module 455 references 1315 atmospheric data corresponding to the vantage point. The atmospheric data may include atmospheric location data and atmospheric modeling data. The image creation module 460 creates 1320 one or more atmospheric images approximating the vantage point. The one or more atmospheric images, in one embodiment, are created from the atmospheric data. The threat potential notification module 450 presents 1325 a notification to the device 140 with the threat potential of the potential threat element and/or the atmospheric image. Then, the method 1300 ends.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
determining a device location, the device location comprising a geographic location of a device;
determining a threat location, the threat location comprising a geographic location of a threat; and
presenting a notification to the device in response to determining that the threat location is within a predetermined distance of the device location.

2. The method of claim 1, further comprising:
associating a second device with the device;
determining a second device location, the second device location comprising a geographic location of the second device;
determining a second threat location, the second threat location comprising a geographic location of a second threat; and
presenting a second notification to the device in response to determining that the second threat location is within a predetermined distance of the second device location.

3. The method of claim 1, further comprising:
determining a first available communication option of a hierarchy of communication options for communicating with the device,
wherein presenting the notification to the device further comprises sending the notification to the device using the first available communication option.

4. The method of claim 1, further comprising:
determining an initial location;
referencing a calendar event, the calendar event comprising an event location and an event time;
determining a route of travel from the initial location to the event location; and
determining that a second threat intersects with the route of travel.

5. The method of claim 4, further comprising presenting a second notification to the device in response to determining that the second threat intersects with the route of travel.

6. The method of claim 1, wherein determining the device location further comprises determining a device vector and determining the threat location further comprises determining a threat vector, the device vector comprising a vector of the device, the threat vector comprising a vector of the threat, the method further comprising determining that the device vector intersects with the threat vector, wherein presenting the notification to the device further comprises presenting the notification to the device in response to determining that the threat location is within a predetermined distance of the device location and that the device vector intersects with the threat vector.

7. The method of claim 1, further comprising referencing a plurality of threat data collections for a plurality of threats, wherein determining the threat location further comprises determining the threat location based on data for the threat in one or more of the threat data collections.

8. The method of claim 1, wherein presenting the notification to the device in response to determining that the threat location is within the predetermined distance of the device location further comprises:
repeating determining the device location and the threat location in response to determining that the threat location is within the predetermined distance of the device location; and
presenting the notification to the device in response to making a second determination that the threat location is within the predetermined distance of the device location.

9. The method of claim 1, wherein the notification comprises an identification of the threat and an intersection time, the intersection time comprising an estimated time of intersection of the threat with the device.

10. The method of claim 1, further comprising initiating a local entity search on the device, wherein the device detects a local wireless transmission signal and displays a presentation associated with the local wireless transmission signal in response to initiating a local entity search on the device.

11. The method of claim 1, further comprising:
receiving a request for additional information; and
displaying collaborative information associated with the threat in response to receiving the request for additional information.

12. An apparatus comprising:
a device location module determining a device location, the device location comprising a geographic location of a device;
a threat location module determining a threat location, the threat location comprising a geographic location of a threat;
a notification module sending a notification to the device in response to determining that the threat location is within a predetermined distance of the device location;
an association module associating a second device with the device; and
the notification module sending a second notification to the device in response to determining that a second threat location of a second threat is within a predetermined distance of a second device location of the second device.

13. The apparatus of claim 12, further comprising:
a communication determination module determining a first available communication option of a hierarchy of communication options for communicating with the device,
wherein sending the notification to the device further comprises sending the notification to the device using the first available communication option.

14. The apparatus of claim 12, further comprising:
a calendar integration module referencing a first calendar event, the first calendar event comprising a first event location and a first event time, the calendar integration module referencing a second calendar event, the second calendar event comprising a second event location and a second event time; and
a route intersection module determining a route of travel from the first event location and the second event location and determining that a second threat intersects with the route of travel.

15. The apparatus of claim 12, wherein the device location module determines a device vector, the device vector comprising a vector of the device, and wherein the threat location module determines a threat vector, the threat vector comprising a vector of the threat, the apparatus further comprising:
an threat determination module determining an intersection time of the device vector and the threat vector,
wherein the notification module sending the notification to the device further comprises the notification module sending the intersection time.

16. A computer program product comprising a computer readable storage medium having computer readable program code embodied therein, the computer readable program code configured to:
determine a device location, the device location comprising a geographic location of a device;
determine a threat location, the threat location comprising a geographic location of a threat;
determine a first available communication option of a hierarchy of communication options for communicating with the device; and
send a notification to the device in response to determining that the threat location is within a predetermined distance of the device location using the first available communication option.

17. The computer program product of claim 16, the computer readable program code further configured to:
associate a second device with the device;
determine a second device location, the second device location comprising a geographic location of the second device;
determine a second threat location, the second threat location comprising a geographic location of a second threat; and
send a second notification to the device in response to determining that the second threat location is within a predetermined distance of the second device location.

18. The computer program product of claim 16, the computer readable program code further configured to:
reference a first calendar event, the first calendar event comprising a first event location and a first event time;
reference a second calendar event, the second calendar event comprising a second event location and a second event time;
determine a route of travel from the first event location and the second event location; and
determine that a second threat intersects with the route of travel.

19. A method comprising:
determining a vantage point of a device, the vantage point comprising a location and a viewing angle;
determining a threat potential of a potential threat element in the vantage point; and
presenting a notification to the device, the notification comprising the threat potential of the potential threat element.

20. The method of claim 19, further comprising:
referencing atmospheric data corresponding to the vantage point, the atmospheric data comprising atmospheric location data and atmospheric modeling data;
creating one or more atmospheric images approximating the vantage point, the one or more atmospheric images created from the atmospheric data; and
presenting the one or more atmospheric images to the device.
